(19) United States
(12) Patent Application Publication
(10) Pub. No.: US 2009/0294724 A1
(43) Pub. Date: Dec. 3, 2009

(54) ANTI-ICING MATERIAL AND SURFACE TREATMENTS

(75) Inventor: Amir J. ATTAR, Raleigh, NC (US)

Correspondence Address: INTELLECTUAL PROPERTY / TECHNOLOGY LAW, PO BOX 14329, RESEARCH TRIANGLE PARK, NC, 27709, US

(73) Assignee: Appealing Products, Inc., Raleigh, NC (US)

(21) Appl. No.: 12/127,518

(22) Filed: May 27, 2008

(51) Int. Cl. C09K 3/18

(52) U.S. Cl. 252/70; 244/134 E; 106/13

(57) ABSTRACT

An anti-icing composition including a chemically-bound nano-layer based on a multivalent atom such as silicon or titanium, and whiskers of hydroxyls, polyols, polyethers, polyamines, poly-acids or mixtures of such hydrophilic functionalities. This base layer may be used as such or have an additional coating overlying it, e.g., comprising a polymeric polyol such as polyvinylalcohol or polyglycol. The second layer may also be chemically bonded to the surface or to the first layer. Surface treatment with such composition prevents small droplets of water from freezing on the surface and reduces dramatically their friction with the surface. The result is the prevention of icing of the surface, reduction in the adhesion of ice to the surface and reduction in the accumulation of ice layers. The anti-icing composition also makes removal of ice from the surface much easier once accumulated, and is useful in reducing de-icing requirements of aircraft and in retarding in-flight ice formation. Other applications include coating window panels and vehicles exposed to icing conditions and preventing bulk particles from adhering to each other in icy conditions.

### FIELD OF THE INVENTION

The present invention relates to compounds and coatings comprising same, which are usefully employed on surfaces to reduce or prevent the formation of ice layers on them and/or facilitate the removal of ice by other means, as well as to associated methodology for the use of such compounds and coatings, e.g., on aircraft and other vehicles.

### BACKGROUND OF THE INVENTION

Ice formation on aircraft has been the cause of multiple fatal accidents and loss of property. Thus, it is desirable to find means and methods to prevent or reduce ice formation on aircraft and on other vehicles.

Accumulation of ice on wings of an aircraft changes the aerodynamics of the wing, and has an adverse effect on the lift produced. Moreover, ice buildup on aircraft wings increases the drag on the aircraft by 30-80%, thus reducing fuel efficiency and increasing the cost of aircraft operation. Additional problems may occur if an ice layer forms on the air intake shutters or across stabilizer fins, such as engine stalling. If the fins are wholly unable to operate, the pilot may lose control of the aircraft. Moreover, even if the wings or fins were ice-free on take-off, flying through ice storms or supersaturated clouds can result in ice buildup on an aircraft. In-flight buildup of ice can prevent air shutters or navigation gear from moving, cause air filters to freeze etc., which in turn reduces the ability of the pilot to maneuver or control the aircraft.

Ice buildup on unmanned aircraft has also proven to be extremely dangerous and the cause of numerous failures of such craft. This is due in part to the fact that such aircraft are typically made out of composites, that these aircraft have very little surplus energy to combat deicing and that they lack the on-board supervision of a pilot. Instances are documented in which icing resulted in engine shut-down and aircraft failure.

In addition to the foregoing, ice buildup on turbine blades of aircraft engines reduces their efficiency, and can result in damage to the blades. In extreme cases, such icing of the engine turbine blades can result in the downing of the aircraft.

Many methods have been devised and some are being routinely used to remove ice/snow from wings and from other parts of aircraft, to reduce the likelihood of accidents. Unfortunately, these methods involve the use of chemicals, heat, hot washes and other energy-intensive and/or environmentally hazardous means. Moreover, the removal of ice from stationary aircraft in an airport setting is not done under strict time pressures and other constraints that are characteristic of in-flight deicing. On ground deicing typically uses much more material, energy and manpower than in-flight deicing. The need for in-flight deicing has motivated efforts to develop anti-ice technologies that are effective to prevent the accumulation of ice or reduce it significantly, yet do not require excessive amounts of energy and materials, or expensive, complicated or heavy hardware.

Despite such efforts, an effective technical solution has not yet been found. Various studies have shown that certain surface coatings can temporarily reduce ice formation on aircraft in flight. Unfortunately, these coatings are susceptible to being irreversibly damaged by water, rain and even ice, in addition to being expensive, hard to repair if damaged, and having only a limited life.

It would therefore be a significant advance in the art to provide an effective means and methodology for combating icing of surfaces and components of aircraft and other objects that are susceptible to icing.

### SUMMARY OF THE INVENTION

This invention relates to various classes of materials that can be bound to a solid surface to confer to it anti-icing properties. In addition, it relates to various methods to chemically bind such anti-icing compounds to the surface, and methods to enhance the strength and the density of chemical bonds between the anti-icing coatings and the solid surface.

The

Other aspects, features embodiments of the invention will be more fully apparent from the ensuing disclosure and appended claims.

### DETAILED DESCRIPTION OF THE INVENTION, AND PREFERRED EMBODIMENTS THEREOF

The present invention relates to compositions and methods for combating icing of surfaces and objects that are susceptible to icing and deleteriously affected by same, e.g., surfaces and components of aircraft.

The invention contemplates the formation of ice-combating layers that are stable, low in cost, repairable, and easy to apply. Such layers are highly effective, particularly when the temperatures are not excessively low, and can prevent ice formation altogether in many cases. Since many aircraft are most vulnerable to icing on take off and landing, when the icing conditions are relatively mild, the ice-combating compositions of the invention are highly attractive for application to aircraft wings and other components of such craft.

When super-cooled droplets of water impinge on moving, inclined solid surfaces at sub-freezing temperatures, the droplets may deliver their enthalpy of freezing and immediately solidify, may move on the surface up or down the incline and solidify, or may leave the surface, depending on the relative speeds of the air and the solid, the angle of inclination and the gravity force, the droplet size, the relative temperatures and other variables. The droplets may also shatter into smaller droplets that freeze instantly, glide some distance and then freeze or glide along the entire length of the surface and leave without freezing. It is desired that as much as possible of the liquid water that impinges on the surface will leave it without solidifying, i.e., without freezing on it.

The surface coatings of the present invention modify the icing of moving surfaces in two major ways: (i) they retard the nucleation of ice crystals on the surface and thus retard the formation of the ice phase, and (ii) they reduce drastically the friction coefficient between the liquid water and the surface and thus allow the water to move and disengage from the surface before it has time to freeze.

The present invention contemplates materials that inhibit the nucleation of water by preventing assembly of molecules on the surface to form ice nuclei, and anchor molecules to surfaces to form stable, water-insoluble layers. When the nucleation is prevented, delayed, or inhibited, liquids can be cooled down to much lower temperatures than their normal solidification temperatures and still remain fluidic. This phenomenon is known as supercooling. Supercooling can be achieved to some extent with all materials. Dissolving salts and other materials in liquids, including water, lower their freezing points, i.e., their solidification temperatures, and help in keeping them liquids.

The present invention provides a surface coating that interferes with the nucleation of ice on a surface, and methods for forming such surface coatings. The ice-inhibiting coatings of the invention are bound chemically to the surface and not used as a simple overlay coating.

In respect of the invention, a thin layer of material that can imbibe water and that covers the surface of a solid, absorbs water and forms a thin solution layer. The freezing temperature of this solution is below the freezing point of ordinary water, since the immobilized solute inhibits the nucleation of ice particles. As long as the water in the coated layer remains liquid, liquid water will not adhere to it and freeze, and ice layers will not form or grow on it, until a much lower temperature is reached than the normal freezing temperature of water. If a very high load of water impacts and totally covers the surface, it may freeze independently of the coating layer. This may in turn allow “sloughing” of the independently frozen water from the underlying coating layer, so that the surface is less impacted by the high water loading than would be the case if the substrate surface were uncoated with the coating material of the invention.

The effectiveness of the surface coating of anti-icing material depends on its ability to imbibe water. Since all the materials that can dissolve or imbibe water are also at least partially water soluble, some of the anti-icing coating may be lost unless the coating is anchored to the solid surface. If the protective layer is not attached to the surface, excessive water will gradually dissolve and remove it and it will have to be renewed. This problem afflicts all coatings developed to date. To prevent this occurrence, water-soluble materials in anti-icing coatings of the invention are bonded chemically to the surface.

Generally, coating layers of any type will be subject to erosion due to wind, particles such as sand, and water erosion. Bonding the coating layer to the underlying surface will reduce such erosion but will not prevent it altogether. The selection of a particular anti-icing coating will therefore be based generally on considerations of stability and effectiveness of the anti-icing layer, its cost, the cost of coating of the aircraft or other substrate, and the stability of the coating.

The coatings of the present invention are highly efficient since they are not leachable or soluble by rain or icy water, and since they are chemically bonded to the substrate, they are not susceptible to being washed from the substrate during normal cleaning operations.

The anti-ice coating material of the present invention comprises chemically-bonded chains of polymeric material derived from monomers containing a multivalent element (MVE) such as carbon, silicon, titanium, zirconium or similar material. In a typical configuration, the active nano-layer of the MVE, denoted M, is bonded to the surface and to two other atoms via oxygen atoms. A fourth bond of the MVE is typically used to bind a radical R that can interact with water. Such radicals can for example include groups such as hydroxyls, OH; carbonyls, CO; ethers, C—O—C—; and the like. The distance between two adjacent MVEs limits the “size” of aggregates of atoms that can fit between them, while the nature of the radical R dictates the way in which water will interact with the surface.

The invention therefore contemplates materials that can be bound to a solid surface to confer anti-icing properties to the surface, as well as various methods to chemically bind anti-icing compounds to the surface. The methods of the invention enhance the strength and the density of chemical bonds between the anti-icing coatings and the solid surface.

Classes of compounds according to the invention that are effective in reducing icing include (i) polyethers, such as those that include one or more [—C2H4-O] groups, (ii) polyhydroxy- or polyol-containing compounds, e.g., glycols, sugars and other saccharides, polyvinyl alcohol and polyhydroxyl polymers such as polyethylene glycol, (iii) poly-amino compounds, including poly-amino polymers where the amino group is a part of a ring, and (iv) multi-carboxylic compounds including polycarboxylic compounds and the salts of such compounds, such as the alkaline and alkaline earth salts of these compounds.

In accordance with the present invention, anti-icing compounds are bound chemically to the surface to be protected against icing. This gives such compositions a much greater stability than water-soluble materials that are used as coatings only. The compositions of the present invention in specific embodiments include polyether moieties and/or polyhydroxy compounds, optionally with additives, with the polyhydroxy and/or polyether compounds being anchored to the surface via covalent chemical bonds and/or cross-linked on the surface to form a two-dimensional layer, or both. Certain polyamines can be used in place of the polyhydroxy compounds.

In the use of the coating compositions of the invention, additional techniques may be employed to improve the stability and performance of the anti-ice layer, including (i) pre-treating the surface to create more surface sites where the treating material can bond chemically, and (ii) adding a layer of a second polyol material on top of the first layer. The second material may be bonded chemically to the initial layer to increase the effective surface concentration of hydroxy, amino or carboxy groups, or the second material may be coated on the first layer to provide another layer containing compounds rich in hydroxyl, amino or carboxy groups.

The two main functions of the surface pre-treatment are (1) to increase the number of active sites on the substrate surface on which the coated nano-layer can bond, and (2) to ensure that the entire substrate surface is activated and available for bonding.

The two main functions of the surface nano-layer coating of the invention are (1) to place on the substrate surface chemically-bonded “whiskers” that retain water in a liquid form that will freeze at a much lower temperature than normal, due to restrictions on the nucleation of ice crystals, and (2) to confer the substrate surface with super-hydrophilic properties that permit water droplets to move on the substrate surface virtually without friction.

Many variations are possible in the implementation of the present invention, as informed by the present disclosure, within the skill of the art.

The present invention enables a two-dimensional polymeric layer to be formed on and chemically bound to a substrate surface. This layer includes interwoven strands of a polymer that is periodically covalently bonded to the solid surface, e.g., via siloxane bonds. In addition, from certain regions of this polymer, branched structures formed by polyol whiskers (POW) protrude in a conformation that is somewhat like a brush, as shown below as a schematic representation of a treated surface.

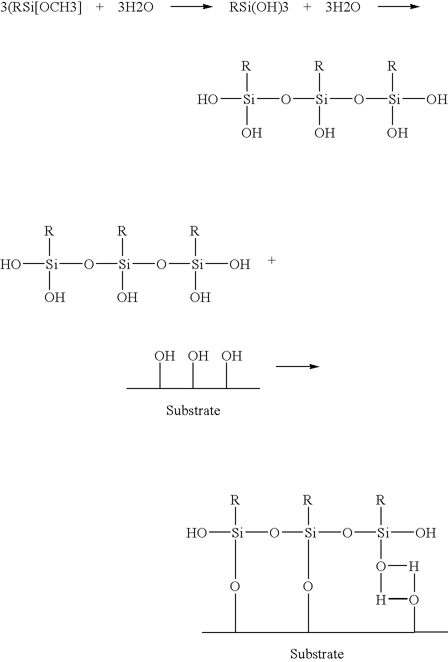

In this schematic representation of the treated surface, the bonded structural layer is an effective anti-ice layer. Such layer optionally can be augmented by a secondary overcoat of a polymer such as polyethylene glycol, (PEG), polyvinylalcohol (PVA), or polymers containing polyethoxy chains.

Polymeric whisker structures can be made using compounds of a multi-valent atom such as silicon, titanium, zirconium, etc. An example of such a synthesis includes the following reactions with a hydroxylated surface, S—OH wherein S is the designation of the surface, and trimethoxy silicon compound(s) such as R-L-Si(OCH₃)₃, wherein L is a linker, e.g., a linker of the formula —CₙH₂ₙ—. The trimethoxysilane moiety hydrolyzes in water to yield hydroxy groups. Although the reactions are shown for trimethoxy silanes, the chemistry is very similar when other types of substitutions are used. Moreover, elements other than silicon or carbon may also be used, including titanium, zirconium, cerium, vanadium and others. For the purpose of illustration, a tri-“leaving group” silane compound, R-L-SiX₃, wherein X is methoxy, is described herein. The reaction mechanisms of the silane compounds are very similar, but the kinetics of the reactions are different.

The chemistry of modifying a surface which includes surface hydroxyls is demonstrated using the trimethoxy silicon compound R-L-Si(OCH₃)₃:

R-L-Si(OCH₃)₃+3H₂O→{R-L-Si(OH)₃}*(Unstable. Partial conversion possible)+3CH₃OH (1)

The reactions between —OH groups on silicon atoms and —OH groups on the solid surface follow and result in binding of the silicon atom covalently to the surface. The OH groups formed by the hydrolysis can react and result in the connection of more monomer molecules in the form of a chain of —O—Si—O—Si— where a linking moiety and the radical R protrude from each Si atom.

Once the substrate surface is coated with the chemically-bound “two-dimensional” polymeric material with the R groups are protruding from it, the surface will appear to external molecules as being covered with Rs. Although the layer is described as “two dimensional,” in reality it is thicker than a monomolecular layer. The nano-layer may be 1-20 atoms thick and made out of interwoven structural strings that are covalently bound to the surface at different locations. The structure of R groups can be modified as necessary to give the surface the desired properties.

To retard the nucleation of ice it is desirable to have on R hydroxy or amino groups but the preferred structure of R is etheric moieties such as —C₂H₄—O—. Such groups act toward water as solutes and serve three functions:
they retard ice nucleation and thus allow the incipiency of an ice layer only at a much lower temperature and supersaturation conditions.
they retain a very thin layer of liquid water on the solid surface, which helps ice or snow particles that are deposited on it to slide away, and
the preferred etheric moieties bond water just strongly enough to increase the surface slip but not strongly enough to prevent the removal of condensed ice from the substrate surface.

The nature of the R groups is very critical to give the surface the desired properties. The effectiveness of the coverage depends on the density of the strands with the functional groups, i.e., the number of available Rs/unit area, while the strength of the bonding to the surface depends on the number of covalent bonds to the surface/unit area. These two functions can be modified independently of one another to produce optimal surface properties, within the skill of the art and without undue experimentation.

In coating the substrate surface with the anti-icing coating of the invention, the surface preferably is cleaned using soap and followed by an intensive wash with water, or other cleaning medium is employed to provide a clean surface. Surfaces that have been contaminated with oil, grease and other materials of similar character, may be cleaned with alcohols, ketones, aromatic solvents and the like, to ensure their cleanliness.

Suitable functionally-terminated Rs, with groups such as silanol terminated, vinyl terminated and amino terminated polydimethylsiloxanes, can be used as anchors to bind highly hydrophilic functionalities. Preferred groups include ethoxylated moieties, methoxylated moieties, cyclic compounds like dioxane, amines, hydroxyls and carboxyls. Other groups may also be effective, as will be appreciated by those skilled in the art, based on the disclosure herein.

The anti-icing compositions of the invention may also include additives to modify the resistive or dielectric properties of the coating.

The coating compositions of the invention can be applied to a substrate surface such as an aircraft surface, in any suitable manner imparting anti-icing properties to the surface of the substrate. In one embodiment, the application procedure for the coating composition may include the following steps:

cleaning the surface;
activating the surface;
applying the surface treatment solution to the surface to form a coating thereon;
curing the coating, and
applying the modification solution for R to the coating.

After the treatment and the modification of the initial R functionality, one may add a second layer including materials such as polyethylene glycol, polyvinyl alcohol, polyacrylic acid, etc. These materials will remain on the surface for a limited time, and will assist the anti-ice effect achieved by the primary bonded layer of anti-icing material.

The surface activation methods used in the practice of the invention may be of any suitable type, and may for example include surface pretreatment steps such as:
1. pretreating the surface with aqueous solutions of alkaline base such as sodium hydroxide, potassium hydroxide, ammonia, etc.;
2. pretreating the surface with aqueous solutions of alkaline salt such as sodium phosphate, sodium carbonate, etc.;
3. pretreating the surface with organic or liquid ammonia solutions of alkali metal or alkali metal conjugates such as sodium naphthalene;
4. pretreating the surface with aqueous solutions of reducing material such as titanium tri-chloride or tin di-chloride; and/or
5. pretreating the surface with aqueous solutions of oxidizers such as nitric acid, solutions of permanganate in dilute acid or in an alkali, solutions of chromate, hydrogen peroxide or the like.

These treatments may be employed independently or in a sequence in combination with one another. They may for example be applied at different concentrations and/or temperatures.

In various illustrative embodiments, activation methods such as the following can be used:
nitric acid treatment (e.g., 5%, 25%, or 69%, for an appropriate time, e.g., 5 minutes, depending on the solid).
sodium tri-phosphate treatment, which may be carried out at various concentrations, e.g., exposure for 10 minutes at 22° C. using a solution of 7.5 gram Na₃PO₄ in 100 ml;
sodium hydroxide treatment, which may be carried out at various concentrations, e.g., exposure for 10 minutes at 22° C. using a solution of 10 gram NaOH in 100 ml;
treatment with a solution of 10 grams of sodium naphthalene in 100 ml tri-ethylene-glycol di-methyl ether for 10 minutes at 22° C. (this solution is particularly useful for fluorinated polymers); and
treatment with a solution of 2.5% titanium tri-chloride in 7.5% hydrochloric acid at 22° C. for 10 minutes.

The invention thus contemplates an anti-icing composition layer on a substrate surface, comprising a polymeric layer chemically bonded to the surface with multiple hydrophilic, hydroxylic or ionic groups attached to the polymer of the polymeric layer or to grafted appendages on the polymeric layer.

Such anti-icing composition layer can be chemically bonded to the surface by multivalent element-oxygen-to-surface bonds, wherein the multivalent atom is selected from the group consisting of silicon, carbon, tin, titanium, germanium, zirconium, hafnium, vanadium and carbon.

In one embodiment, the multivalent element is selected from the group consisting of silicon, titanium and zirconium.

In another embodiment, the polymeric layer comprises a polymer formed by monomers containing hydrolysable mono, di or tri-X-silicones wherein each X is independently selected from the group consisting of chlorine, bromine, iodine, acrylates, methacrylates, aryl-sulfonates, alkyl-phosphates, ethylene amines, aliphatic acids, aliphatic hydroxy acids, alkoxy groups, methoxy, ethoxy, iso-propoxy, di-silazanes, hydrolysable nitrogen moieties, hydrolysable sulfur moieties, and hydrolysable phosphorous moieties.

The anti-icing composition layer on the substrate surface may comprise a polymer formed by monomers containing two or more terminal tri-X-multivalent element groups, wherein X is a hydrolysable group, or alternatively a polymer formed by monomers containing a mixture of di-tri-X-multivalent element and mono-tri-X-multivalent element compounds. The multivalent element in the monomers containing hydrolysable tri-X-multivalent element can also be attached to a reactive organic radical, such as for example, chlorine, bromine, iodine, epoxide, carbonyl, nitrile, cyano, amine-including aromatic or aliphatic primary, secondary, tertiary and quaternary amines and their salts, chlorides, bromides, sulfates, nitrile, amides, esters, ethers, alkoxy, methoxy, ethoxy, thioalkyl, epoxide, vinyl, phosphine, phosphates, sulfonic or halo-sulfonic groups.

The anti-icing composition layer may be formed on a substrate surface, with the polymeric layer being deposited on the surface by first partially hydrolyzing a tri-X-multivalent element, and applying the resulting partially-hydrolyzed mixture to the surface.

The anti-icing composition layer may be applied to the substrate by spraying onto the substrate for coating of the surface thereof.

The anti-icing composition layer, once formed, may then have a secondary coating applied on the polymeric layer to increase its hydrophilicity. The secondary coating can include multi-hydroxy, poly-carboxy or poly-amino polymeric compounds selected from the group consisting of poly vinyl alcohol and its homologs, poly ethylene glycol and its homologs, polyacrylic acid and its homologs, polyimines, polyamines and polymeric salts.

The anti-icing composition layer may be formed on the substrate surface after such surface is pretreated. The surface may be pretreated by a technique selected from among:

(a) functionalizing the surface with hydroxy, carboxy, carbonyl, carbonyls, amino or sulfonic groups to increase bonding of monomers of the polymeric layer to the surface;
(b) contacting the surface with an alkaline base, e.g., a base selected from the group consisting of sodium hydroxide, potassium hydroxide, ammonium, and calcium hydroxide;
(c) contacting the surface with an aqueous solution of an alkaline salt, e.g., a salt including a cation selected from the group consisting of sodium, potassium, calcium, lithium, cesium, and rubidium, and an anionic moiety selected from the group consisting of phosphate, carbonate, sulfide, borate, acetate, organic sulfonate, and organic phosphate;
(d) contacting the surface with an organic amine;
(e) contacting the surface with an aqueous solution of an oxidizer, e.g., an oxidizer selected from the group consisting of permanganate, chromate, persulphate, perphosphate, and peroxide;
(f) contacting the surface with a solution of a metalite complex, e.g., a complex selected from the group consisting of sodium naphthalene and potassium naphthalene; and
(g) contacting the surface with an aqueous solution of a reducing agent, e.g., a reducing agent selected from the group consisting of titanium trichloride and tin chloride.

The pretreatment in one embodiment comprises a technique selected from among oxidation of the surface, oxidation of the surface followed by hydrolysis, introduction of ions onto the surface via acidic or amino groups, and functionalizing the surface with carbonyl or epoxide groups.

In the formation of the anti-icing composition layer on a substrate surface, wherein the layer includes a reactive functionality, a second treatment can be used to activate the functionality, e.g., a reactive organic radical, wherein the activation comprises one or more of hydrolysis, oxidation and diazotation. In such instance, a third reaction can be used to couple a multi-hydroxy compound to the activated functionality, e.g., activated organic radical, such as etherization, esterification, diazo-coupling and/or formation of a salt.

Curing of the anti-icing composition layer on the substrate surface may be carried out at any suitable conditions. Curing may for example be carried out with hot air in a temperature range of 25 to 300° C., for a period of from 0 to 120 minutes, in one embodiment. In another embodiment, the anti-icing composition layer is cured at temperature in a range of 120-170° C. and duration of curing is in a range of 5 to 30 minutes.

When the applied anti-icing composition layer is hydrolyzed to effect hydrolysis of monomer in the applied film, the monomer may be hydrolyzed at any suitable conditions, e.g., a pH range of 1 to 8, and/or a temperature range of 0 to 60° C., in an aqueous solution in which concentration of the monomer is in a range of from 0.001 to 20% by weight, based on total weight of the solution.

The monomer(s) of the anti-icing polymeric layer can be of any suitable types and varieties. For example, the monomers in various embodiments of the invention can include monomers such as N-(3-Triethoxysilyl propyl) gluconamide, tris(acrylic acid) titanium ethoxylate, 2-[Methoxy(polyethyleneoxy)propyl], and/or neopentyl(dially)oxy tris(acrylic acid) zirconate.

Although various aspects, features and embodiments of the invention have been variously illustratively described, it will be appreciated that individual features of the disclosure herein may be utilized in combinations and/or permutative arrangements in which one or more of such features may be utilized to the exclusion of others, and that therefore the present disclosure constitutes a source from which specific features may be isolated and aggregated, within the scope of the invention.

The features and advantages of the invention are more fully appreciated from the ensuing examples, which are not intended to be in any way limiting, but merely illustrative of the invention in various specific embodiments thereof.

### Example 1

### Application of Initial Active Coating

Surface to be treated: aluminum coupon or coupons of carbon-fiber reinforced epoxy (CRE).
Surface Pretreatment: wash with soap and water to remove all dirt and oils; if still unclean, wash with solvent, such as toluene, and then wash with isopropanol followed by drying.
Surface Activation: methods of the type discussed hereinabove give acceptable results.
Material for Treatment: N-(3-triethoxysilylpropyl) gluconamide in 50% ethanol, which may optionally be diluted with absolute alcohol or absolute isopropanol down to 3%.
Treating Method: spray the surface with the solution at ambient temperature and let it stand for at least 3 minutes.
Curing the Surface: air drying for 15 minutes followed by 65° C. air for 30 minutes.
Testing Method Static technique. Water droplets, smaller than 50 microliters, are placed on the sample surface at least 1 mm apart and the sample is cooled to at least −7.5° C. in water-saturated air for at least three days. The sample surface is examined to determine if the water has frozen on it or not; in some cases, a small amount of titanium dioxide powder (250 mesh) is added to the water to help visualize and photograph the droplets.
Testing Method Dynamic technique. Cool the surface to about −3.9° C. and expose it to an air stream at 80 knots (92 miles/hr) carrying 0.4 gm water/m³ in the form of droplets having a size of 20 microns at a temperature of ˜−3.9° C. at an angle of attack of 45 degrees, for a period of 10 minutes. Tests were conducted with water loading in the range of 0-1.15 gm/m³, angles of attack of 6-65 degrees, temperatures in the range of 20-30° F., and air velocities of up to 115 knots.
Evaluation Criteria If the water droplets do not freeze on the treated surface but freeze on the surface of a control sample that was not treated, then the treated surface and the treatment method are acceptable. The accumulation of ice and its shapes were examined and compared.

### Example 1.1

### Treatment of Cleaned Aluminum Coupons

The treated surface did not permit the water to freeze.

### Example 1.2

### Treatment of Aluminum Coupons Cleaned with Sodium Phosphate

There was no meaningful difference between aluminum coupons cleaned with sodium phosphate and those cleaned with water.

### Example 1.3

### Treatment of Aluminum Coupons Cleaned with Sodium Phosphate and Subsequently Oxidized with Concentrated Nitric Acid

The treated surface resulted in the most uniform coating and the coating prevented water from freezing on it.

### Example 1.4

### Treatment of Aluminum Coupons Cleaned with Sodium Phosphate and Subsequently Oxidized with Concentrated Nitric Acid, Washed and Following the Treatment with a Coat of Polyethylene Glycol. (PEG)

The treated surface resulted in an extremely uniform coating and the coating prevented water from freezing on it.

### Example 1.5

### Treatment of Cleaned Epoxy Coupons

The treated surface did not permit the water to freeze.

### Example 1.6

### Treatment of Epoxy Coupons Cleaned with Methanol and Subsequently Oxidized with Sodium Hypochlorite Solution

The treated surface resulted in the most uniform coating and the coating prevented water from freezing on it.

### Example 1.7

### Treatment of Epoxy Coupons Cleaned with Methanol and Subsequently Oxidized with Hypochlorite Solution, Washed and Following the Treatment with a Coat of Polyethylene Glycol (PEG)

The treated surface resulted in an extremely uniform coating and the coating prevented water from freezing on it.

### Example 2

### Two-Stage Coating-First Coating with a Simple Silicone Followed by Reaction of the Vinyl Group With Free Radical Graft Polymerization

The treatment in this example refers to both cleaned aluminum and epoxy surfaces but works more efficiently on epoxy.

In this example, (3-acryloxypropyl) trimethoxysilane, (APTMS), CH₂═CHC(O)OCH₂CH₂CH₂Si(OCH₃)₃, was used as the reagent for the first stage of the treatment. A 2% solution of APTMS in 70% IPA was prepared and its pH was adjusted with dilute acetic acid to 4.5. The mixture was stirred for 12 minutes and sprayed on the surface.

### Example 2.1

An aqueous solution of 5% ascorbic acid in 8% sodium carbonate with 0.3% of the catalyst t-butyl-hydroperoxide, and a second treating reagent of ascorbic acid, is employed. Light helps the formation of the film at temperatures below 25° C. The solution must be applied immediately after preparation. Small amounts of EDTA improve its pot life.

### Example 2.2

An aqueous solution of 5% maleic acid in 8% sodium carbonate with 0.3% of the catalyst t-butyl-hydroperoxide, and a second treating reagent of ascorbic acid, are employed. Light helps the formation of the film at temperatures below 25° C. The solution must be applied immediately after preparation. Small amounts of EDTA improve its pot life. Fumaric acid reacts in a similar way.

### Example 2.3

An aqueous solution of 1-5% partially dehydroxylated sugar, (PDHS), in acidic or basic pH, with 0.3% of the catalyst t-butyl-hydroperoxide and the second treating reagent ascorbic acid. Light helps the formation of the film at temperatures below 25 C. The solution must be applied immediately after preparation. Small amounts of EDTA improve its pot life.

The PDHS is obtained by adding 10 grams anhydrous zinc chloride to 30 grams sugar in 50 ml 100% IPA and warming the mixture to 60° C. for 30 minutes while stirring constantly. A slight discoloration may occur. The solution is then treated with 10 grams of sodium carbonate in 20 ml water and filtered to remove the white zinc carbonate formed. The solution has to be stored in the dark.

### Example 2.4

A 0.4 molar solution of sodium acrylate with 0.2 molar triethanol amine in 5% hydrogen peroxide was prepared and warmed up to 95 C. Cupric sulfate was added to 3000 ppm Cu⁺² and the solution was quickly sprayed on the surface treated with APTMS. The spraying was repeated three times at 15 minute intervals.

Droplets of water of 50 microliters in size did not freeze on the surface after exposure to −7.5° C. for three days in air saturated with water vapors.

### Example 3

### Two Stage Coating. First Coating as an Aromatic Amino Silicone, Second Coating applied by Diazotizing the Amino Group With a Nitrite and Following with a Reaction with Hydroxylated Aromatic Compound

The treatment in this example refers to both cleaned aluminum and epoxy surfaces but works more efficiently on epoxy.

In all the tests described p-tri-methoxy-aniline (TMA) was used, but other tri-X silanes, or other aromatic amines, may also be used equally well. The 2% TMA solution in 71% IPA was applied to the surface after adjusting its pH to 4.5 and stirring it 15 minutes. The surface was then treated with 5% solution of sodium nitrite in water, pH of 4.5, adjusted using acetic acid. (Citric acid works equally well).

### Example 3.1

### Using a Hydroxy-Terminated Multi-Ethoxide in Aqueous Solution

A 3% solution of p-tri-ethoxy-phenol at 40° C. was sprayed on the surface and let dry.

### Example 3.2

### Using a Hydroxy-Terminated Multi-Ethoxide in Aqueous Solution with a Secondary Coating of Poly-Vinyl-Alcohol

The surface obtained in Example 3.1 was further sprayed with 3% poly-vinyl-alcohol, at 50° C. and the solution was allowed to dry. This treatment gave excellent results both for aluminum and epoxy surfaces.

### Example 4

### Using the Ethoxylated Silicon Compound 2-[methoxy(polyethylenoxy)propyl]-trimethoxysilane as the First Treatment

The treatment in this example refers to both cleaned aluminum and epoxy surfaces, but works more efficiently on epoxy. The results obtained were excellent and the treated surface was relatively stable over three icing cycles.

The following examples use titanate compositions.

### Example 5

### Single Initial Active Coating

Surface to be Treated: Aluminum coupon or coupons of carbon-fiber reinforced epoxy (CRE).
Surface Pretreatment: Wash with soap and water to remove all dirt and oils, followed by a wash with a solvent such as toluene and then with isopropanol followed by drying.
Surface Activation: Previously described surface activation methods give acceptable results.
Treating material: 0.1% Tris-acrylic-titanium tri-ethoxylate-methoxide (TATEM) in 91% IPA was used in all examples with titanium.
Treating Method: Spray the surface with the solution at ambient temperature and let it stay there for at least 15 minutes.
Curing the Surface: Blow hot air at 65 C for 30 minutes.
Testing Method: Water droplets, smaller than 50 microliters, are placed on the sample surface at least 1 mm apart and the sample is cooled to at least −7.5° C. in water-saturated air for at least three days. The sample surface is examined to determine if the water froze on it or not. In some cases, a small amount of titanium dioxide powder (250 mesh) is added to the water to help visualize and photograph the droplets.
Evaluation Criteria: Static. If the water droplets do not freeze on the treated surface but freeze on the surface of a control sample which was not treated, then the treated surface and the treatment method are acceptable.
Testing Method: Dynamic. Cool the surface to about −3.9° C. and expose it to air stream at 80 knots, (92 miles/hr) carrying 0.4 gm water/m³, with droplets size of 20 microns at ˜−3.9° C. at an angle of attack of 45 degrees, for a period of 10 minutes. Tests were conducted with water loading in the range of 0-1.15 gm/m³, angles of attack of 6-65 degrees, temperatures in the range of 20-30° F., and air velocities of up to 115 knots.
Evaluation Criteria: If the water droplets do not freeze on the treated surface but freeze on the surface of a control sample that was not treated, then the treated surface and the treatment method are acceptable. The accumulation of ice and its shapes were examined and compared.

### Example 5.1

### Use of a Titanate Compound After Surface Activation with Sodium Hydroxide Solution

A 2.5 Molar solution of sodium hydroxide was placed on the surface for 10 minutes at room temperature. After this pretreatment, the surface was treated with a 0.1% solution of TATEM. This was allowed to dry at room temperature for 15 minutes, and then cured at 65 degrees Celsius for 30 minutes. This treatment provided the lowest contact angle of any surface prepared during the testing.

### Example 5.2

Use of Titanate Compound After Pretreatment of a Surface Using a Phosphate Solution

A 10% solution of tribasic sodium phosphate was placed on the surface for 10 minutes at room temperature. After this pretreatment, the surface was treated with a 0.1% solution of TATEM in 91% isopropyl alcohol. This was allowed to dry at room temperature for 15 minutes, and then cured at 65 degrees Celsius for 30 minutes.

### Example 5.3

### Use of Titanate Compound After Pretreatment of a Surface Using a Reduction Step

A 10% solution of titanium (III) chloride was placed on the surface for 10 minutes at room temperature. After this pretreatment, the surface was treated with a 0.1% solution of TATEM in 91% isopropyl alcohol. This was allowed to dry at room temperature for 15 minutes, and then cured at 65 degrees Celsius for 30 minutes.

### Example 5.4

### Use of Titanate Compound After Pretreatment of a Surface Using an Oxidation Step

A 5% solution of hydrogen peroxide was placed on the surface for 10 minutes at room temperature. After this pretreatment, the surface was treated with a 0.1% solution of TATEM in 91% isopropyl alcohol. This was allowed to dry at room temperature for 15 minutes, and then cured at 65° C. for 30 minutes.

### Example 6

### Use of the Zirconium Compound neopentyl(diallyl)oxy Triacryl Zirconate, (NPDATAZ), after Pretreatment of a Surface Using Alkali Solution

A 2.5 Molar solution of sodium hydroxide was placed on the surface for 10 minutes at room temperature. After this pretreatment, the surface was treated with a 0.1% solution of TATEM in 91% isopropyl alcohol. This was allowed to dry at room temperature for 15 minutes, and then cured at 65 degrees Celsius for 30 minutes. The results with the zirconate were not as definitive as with the titanates.

While the invention has been described herein with reference to specific features, aspects and embodiments, it will be appreciated that the invention is not thus limited, but rather extends to and encompasses numerous variations, modifications and other embodiments, such as will suggest themselves to those of ordinary skill in the art, based on the disclosure herein. Accordingly, the invention is intended to be broadly construed to encompass such variations, modifications and other embodiments, as being within the spirit and scope of the invention as hereinafter claimed.

What is claimed is:

1. An anti-icing composition layer on a substrate surface, comprising a polymeric layer chemically bonded to the surface with multiple hydrophilic, hydroxylic or ionic groups attached to the polymer of said polymeric layer or to grafted appendages on the polymeric layer.

2. The anti-icing composition layer on a substrate surface according to claim 1, wherein the layer is chemically bonded to the surface by multivalent element-oxygen-to-surface bonds and wherein the multivalent atom is selected from the group consisting of silicon, carbon, tin, titanium, germanium, zirconium, hafnium, vanadium and carbon.

3. The anti-icing composition layer on a substrate surface according to claim 1, wherein the multivalent element is selected from the group consisting of silicon, titanium and zirconium.

4. The anti-icing composition layer on a substrate surface according to claim 1, wherein the polymeric layer comprises a polymer formed by monomers containing hydrolysable mono, di or tri-X-silicones wherein each X is independently selected from the group consisting of chlorine, bromine, iodine, acrylates, methacrylates, aryl-sulfonates, alkyl-phosphates, ethylene amines, aliphatic acids, aliphatic hydroxy acids, alkoxy groups, methoxy, ethoxy, iso-propoxy, di-silazanes, hydrolysable nitrogen moieties, hydrolysable sulfur moieties, and hydrolysable phosphorous moieties.

5. The anti-icing composition layer on a substrate surface according to claim 1, wherein the polymeric layer comprises a polymer formed by monomers containing two or more terminal tri-X-multivalent element groups, wherein X is a hydrolysable group.

6. The anti-icing composition layer on a substrate surface according to claim 1, wherein the polymeric layer comprises a polymer formed by monomers containing a mixture of di-tri-X-multivalent element and mono-tri-X-multivalent element compounds.

7. The anti-icing composition layer on a substrate surface according to claim 1, wherein the multivalent element in the monomers containing hydrolysable tri-X-multivalent element is also attached to a reactive organic radical.

8. The anti-icing composition layer on a substrate surface according to claim 7, wherein the organic radical is selected from the group consisting of chlorine, bromine, iodine, epoxide, carbonyl, nitrile, cyano, amine-including aromatic or aliphatic primary, secondary, tertiary and quaternary amines and their salts, chlorides, bromides, sulfates, nitrile, amides, esters, ethers, alkoxy, methoxy, ethoxy, thioalkyl, epoxide, vinyl, phosphine, phosphates, sulfonic and halo-sulfonic groups.

9. The anti-icing composition layer on a substrate surface according to claim 1, wherein the polymeric layer is deposited on the surface by first partially hydrolyzing a tri-X-multivalent element, and applying the resulting partially-hydrolyzed mixture to the surface.

10. The anti-icing composition layer on a substrate surface according to claim 1, wherein the polymeric layer is sprayed onto the surface for coating thereof.

11. The anti-icing composition layer on a substrate surface according to claim 1, further comprising a secondary coating on the polymeric layer to increase its hydrophilicity.

12. The anti-icing composition layer on a substrate surface according to claim 11, wherein the secondary coating includes multi-hydroxy, poly-carboxy or poly-amino polymeric compounds selected from the group consisting of poly vinyl alcohol and its homologs, poly ethylene glycol and its homologs, polyacrylic acid and its homologs, polyimines, polyamines and polymeric salts.

13. The anti-icing composition layer on a substrate surface according to claim 1, wherein the surface is a pretreated surface.

14. The anti-icing composition layer on a substrate surface according to claim 13, wherein the pretreated surface has been pretreated by a technique selected from among:
(a) functionalizing the surface with hydroxy, carboxy, carbonyl, carbonyls, amino or sulfonic groups to increase bonding of monomers of the polymeric layer to the surface;
(b) contacting the surface with an alkaline base selected from the group consisting of sodium hydroxide, potassium hydroxide, ammonium, and calcium hydroxide;
(c) contacting the surface with an aqueous solution of an alkaline salt including a cation selected from the group consisting of sodium, potassium, calcium, lithium, cesium, and rubidium, and an anionic moiety selected from the group consisting of phosphate, carbonate, sulfide, borate, acetate, organic sulfonate, and organic phosphate;
(d) contacting the surface with an organic amine;
(e) contacting the surface with an aqueous solution of an oxidizer selected from the group consisting of permanganate, chromate, persulphate, perphosphate, and peroxide;
(f) contacting the surface with a solution of a metalite complex selected from the group consisting of sodium naphthalene and potassium naphthalene; and
(g) contacting the surface with an aqueous solution of a reducing agent selected from the group consisting of titanium trichloride and tin chloride.

15. The anti-icing composition layer on a substrate surface according to claim 13, wherein the pretreated surface has been pretreated by a technique selected from among oxidation of the surface, oxidation of the surface followed by hydrolysis, introduction of ions onto the surface via acidic or amino groups, and functionalizing the surface with carbonyl or epoxide groups.

16. The anti-icing composition layer on a substrate surface according to claim 7, wherein a second treatment is used to activate the reactive organic radical and wherein the activation comprises one or more of hydrolysis, oxidation and diazotation.

17. The anti-icing composition layer on a substrate surface according to claim 16, wherein a third reaction is used to couple a multi-hydroxy compound to the activated organic radical and wherein the third reaction is selected from the group consisting of etherization, esterification, diazo-coupling and formation of a salt.

18. The anti-icing composition layer on a substrate surface according to claim 1, wherein the anti-icing composition layer is cured by hot air in a temperature range of 25 to 300° C., for a period of from 0 to 120 minutes.

19. The anti-icing composition layer on a substrate surface according to claim 1, wherein the anti-icing composition layer is cured at temperature in a range of 120-170° C. and duration of curing is in a range of 5 to 30 minutes.

20. The anti-icing composition layer on a substrate surface according to claim 1, wherein monomer of said polymeric layer is hydrolyzed in a pH range of 1 to 8.

21. The anti-icing composition layer on a substrate surface according to claim 1, wherein monomer of said polymeric layer is hydrolyzed in a temperature range of 0 to 60° C., in an aqueous solution in which concentration of the monomer is in a range of from 0.001 to 20% by weight, based on total weight of the solution.

22. The anti-icing composition layer on a substrate surface according to claim 1, wherein monomer of said polymeric layer is selected from among N-(3-Triethoxysilyl propyl) gluconamide, tris(acrylic acid) titanium ethoxylate, 2-[Methoxy(polyethyleneoxy)propyl], and neopentyl(dially)oxy tris(acrylic acid) zirconate.
